(19) United States
(12) Patent Application Publication
(10) Pub. No.: US 2025/0392383 A1
(43) Pub. Date: Dec. 25, 2025

(54) METHOD FOR DIAGNOSING INTERFERENCE IN A TERMINATION DEVICE OF A PASSIVE OPTICAL COMMUNICATIONS NETWORK, AND CORRESPONDING COMPUTER PROGRAM AND DEVICE

(71) Applicant: ORANGE, Issy-les-Moulineaux (FR)

(72) Inventor: Philippe Chanclou, Châtillon Cedex (FR)

(21) Appl. No.: 18/878,717

(22) PCT Filed: Jun. 15, 2023
(86) PCT No.: PCT/EP2023/066085

§ 371 Date: Dec. 24, 2024

(30) Foreign Application Priority Data
Jun. 28, 2022 (FR) FR2206466

(51) Int. Cl. H04B 10/077; H04B 10/272

(52) U.S. Cl. CPC H04B 10/0775; H04B 10/272

(57) ABSTRACT

In using a passive optical network having an optical line terminal connected to a plurality of optical network units through a tree architecture, it can occur that some of the optical network units, or the optical line terminal, malfunction, sometimes to the extent that they have to be replaced. These malfunctions negatively affect the operation of the network and consequently user experience quality. A method is provided for diagnosing interference which makes it possible to evaluate the impact of a change in the transmission power for an optical signal for one termination device belonging to a passive optical network on the other termination devices of the passive optical network, in particular for the purpose of evaluating possibilities for parametrically optimizing the termination devices.

### FIELD OF THE INVENTION

The invention relates to the field of passive optical networks or PON networks (standing for “Passive Optical Network” in English).

More particularly, the invention relates to a technique for diagnosing communication interferences generated by a termination device of the PON on at least one other termination device.

The invention applies more particularly, yet not exclusively, to new-generation optical networks of the G-PON (defined according to the standard ITU-T G.984), NG-PON or NG-PON-2 (defined according to the standard ITU-T G.989) or XGS-PON (defined according to the standard ITU-T G.9807) type.

### PRIOR ART AND ITS DRAWBACKS

In recent years, increasing demands from users for bandwidth and quality of service have incited researchers to develop new architectures and new protocols for optical communication networks.

The PON architecture is a passive point-to-multipoint architecture which offers high-speed optical access to a population of essentially remote residential users (typically over several tens of kilometers). This architecture is characterized by the absence of active equipment along the branches of the network connecting the optical central office to the user modules.

Conventionally, a PON network 100 comprises, as illustrated in FIG. 1, an optical line terminal (or OLT, standing for “Optical Line Terminal”) 10 located at the level of the optical central office (or CO standing for “Central Office”) connected to an optical coupler 30 via a first optical fiber 20, as well as a set of user modules (or ONUs, standing for “Optical Network Unit”) referenced ONU-1 to ONU-n (n possibly reaching 64). The user modules ONU-1 to ONU-n are respectively connected to the coupler 30 by means of dedicated optical fibers 40-1 to 40-n.

The OLT 10 transmits to the ONUs a downlink optical signal and each ONU transmits to the OLT an uplink optical signal in a time interval that is specific thereto. For the OLT 10 to be able to identify the uplink optical signal specific to each ONU, a transmission schedule is imposed beforehand on each ONU. Hence, the OLT is configured to optically serve the ONUs via the shared fiber 20 passively via the coupler/combiner 30 according to a 1-to-n topology and a defined communication schedule.

During the operation of a passive optical network, it happens that some ONUs or the OLT itself malfunction(s) sometimes to the extent that they have to be replaced. These malfunctions negatively affect the operation of the network and consequently the user experience quality.

Consequently, there is a need to detect and qualify the impact of these malfunctions on the operation of the network.

The present invention aims to solve all or part of these drawbacks.

### DISCLOSURE OF THE INVENTION

The invention addresses this need by providing a method for diagnosing interferences generated by at least one first termination device, located at an end of a first branch of a passive optical communication network or PON, on at least one second termination device located at an end of at least one second branch of said PON.

Such a method is particular in that it comprises the following steps implemented by an interference diagnosis module:
transmitting to said first termination device a request to transmit at least one first optical signal, so-called test signal, at a first transmission power;
transmitting to the second termination device a request to transmit at least one second optical signal at a second transmission power, so-called nominal power,
obtaining, for said second optical signal, at least one measurement of a value of at least one indicator of quality of reception of said second optical signal by a third termination device;
establishing the interference diagnosis of said second termination device as a function of said measured value of at least one reception quality indicator of said second optical signal.

Such an interference diagnosis method allows assessing the impact of a modification of the transmission power of an optical signal of a termination device belonging to a PON on the other termination devices belonging to the PON in particular for the purposes of assessing the parametric optimization possibilities of the termination devices. By “termination device”, it should be understood an optoelectronic device comprising means for transmitting an optical signal at a given transmission power and means for receiving an optical signal transmitted by at least one other termination device.

To this end, a first termination device transmits a first optical test signal at a first transmission power transmitted by the PON. Following the transmission of this optical test signal transmitted by the PON, at least one second termination device transmits a second optical signal at a nominal transmission power transmitted by the PON. A third termination device, having transmitted neither the first test optical signal nor the second optical signal, measures at least one value of at least one reception quality indicator of said second signal allowing establishing the interference diagnosis. In the remainder of the present document, the term “measurement” should be interpreted as meaning “estimate” or “determination” of the value of at least one reception quality indicator of said second optical signal.

The interference diagnosis method object of the present invention is implemented for example when a new termination device is introduced into the PON or when a termination device has a malfunction or when a termination device has a communication quality level lower than a threshold.

According to an aspect of the interference diagnosis method, the latter comprises, prior to establishing said interference diagnosis, a step of transmitting, to the first termination device and to said at least one second termination device a transmission schedule of said test optical signal and of said at least one second optical signal, said transmission schedule being divided into a succession of transmission windows, a transmission window comprising:
a first time interval during which said first termination device is authorized to transmit the test optical signal;
at least one second time interval during which said at least one second device is authorized to transmit said second optical signal at the nominal transmission power, a value of the first transmission power of the test optical signal varying from one time window to another.

The transmission of a transmission schedule allows waking up the termination devices concerned by the progress of the test and thus achieving energy savings. The transmission schedule allows temporally arbitrating the speech times imposed on the different termination devices, for good coordination of these with one another for the implementation of the invention.

Such a transmission schedule proposes a repeated succession of transmission of the test signal by a first termination device followed by the transmission of at least one second optical signal at the nominal power by each of the termination devices concerned by the transmission schedule.

At each transmission of the test signal by said first termination device, the value of the transmission power of the test signal is modified in order to determine which transmission power value generates interferences on the others termination devices.

According to another aspect of the interference diagnosis method, the step of obtaining at least one measurement of a value of at least one reception quality indicator of said second optical signal comprises:
comparing said measured value of at least one reception quality indicator of said second optical signal with a first threshold;
when the measured value of at least one reception quality indicator of said second optical signal is lower than or equal to the first threshold, memorizing an identifier of the first termination device, an identifier of the second device and a value of said first transmission power.

Thus, the interference diagnosis module can identify, from among all of the termination devices belonging to the PON which is a source of interferences, the value of the transmission power for which this termination device generates interferences and finally which are negatively affected by the transmission of the test signal.

According to an aspect of the interference diagnosis method, the step of obtaining at least one measurement of the value of at least one reception quality indicator of said second optical signal further comprises:
comparing said measured value of at least one reception quality indicator of said second optical signal with a second threshold lower than the first threshold;
when the measured value of at least one reception quality indicator of said second optical signal is lower than or equal to the second threshold, memorizing an identifier of the first termination device, an identifier of the second device, a value of said first transmission power, and off-hook information of the second termination device.

Thus, the interference diagnosis module can identify, from among all of the termination devices belonging to the PON which is a source of interferences, the value of the transmission power for which this termination device generates interferences and finally which are negatively affected by the transmission of the test signal to the extent that they hook off, i.e. to the extent that they are no longer functional.

According to still another aspect of the interference diagnosis method, said at least one reception quality indicator of said second optical signal belongs to the group comprising:
a reception power level of said second optical signal measured by said third termination device;
a bit error rate of said second optical signal estimated by said third termination device.

Thus, several reception quality indicators of an optical signal may be considered for the implementation of the invention. Typically, for a given termination device, a difference between a measured reception power level and an expected reception power level lower than a threshold means that the value of the transmission power of the test signal used during the measurement affects the considered termination device. Similarly, a bit error rate higher than a threshold means for example that the transmission power value of the test signal for the current measurement affects the considered termination device.

According to another aspect of the interference diagnosis method, the PON comprising an optical central office connected to at least one first line termination equipment via at least one optical fiber forming said first branch of said PON and to at least one second line termination equipment via at least one other optical fiber forming said second branch of said PON, the first termination device is embedded in the first line termination equipment, the second termination device is embedded in the second line termination equipment, and the third termination device is embedded in the optical central office.

In this case, the interference diagnosis method allows diagnosing the impact of the transmission of a line termination equipment located in the premises of an end user on the other line termination equipment belonging to the PON.

According to another aspect of the interference diagnosis method, the PON comprising an optical central office connected to at least one first line termination equipment via at least one optical fiber forming said first branch of said PON and to at least one second line termination equipment via at least one other optical fiber forming said second branch of said PON, the first termination device is embedded in the optical central office and transmits the test optical signal to the first termination equipment, the second termination device is also embedded in the optical central office and transmits the second optical signal to the second termination equipment, and the third termination device is embedded in the second termination equipment.

In this case, the interference diagnosis method allows diagnosing, for example when the optical central office is equipped with a double operating interface, such as an MPM (“Multi-PON Module”) interface enabling the simultaneous use of the G-PON and XGS-PON technologies within the same PON, the impact of a termination device compliant with the G-PON technology on the termination device compliant with the XGS-PON technology

Another object of the invention is a module for diagnosing interferences generated by at least one first termination device, located at an end of a first branch of a passive optical communication network or PON, on at least one second termination device located at an end of at least one second branch of said PON.

Such an interference diagnosis module comprises at least one processor configured to:
transmit to the first termination device a request to transmit at least one first optical signal, so-called test signal, at a first transmission power;
transmit to the second termination device a request to transmit at least one second optical signal at a second transmission power, so-called nominal power,
obtain, for said second optical signal, at least one measurement of a value of at least one indicator of quality of reception of said second optical signal by a third termination device;
establish the interference diagnosis of said second termination device as a function of said measured value of at least one reception quality indicator of said second optical signal.

According to an aspect of the interference diagnosis module, the PON comprising an optical central office connected to at least one first line termination equipment via at least one optical fiber forming said first branch of said PON and to at least one second line termination equipment via at least one other optical fiber forming said second branch of said PON, said interference diagnosis module is embedded in the optical central office.

Thus, the interference diagnosis module may be a remote server communicating at least with the optical central office of the PON or be embedded in the optical central office.

In the first case, the diagnosis is established on the basis of measurement information received by the interference diagnosis module originating from the optical central office for example. In the second case, the diagnosis is established by the optical central office itself.

Finally, the invention relates to a computer program product comprising program code instructions for implementing a method as described before, when it is executed by a processor.

The invention also relates to a computer-readable recording medium on which a computer program is recorded comprising program code instructions for executing the steps of the method according to the invention as described hereinabove.

Such a recording medium may be any entity or device capable of storing the program. For example, the medium may include a storage means, such as a ROM, for example a CD ROM or a microelectronic circuit ROM, or a magnetic recording means, for example a USB key or a hard disk.

On the other hand, such a recording medium may be a transmissible medium such as an electrical or optical signal, which can be conveyed via an electrical or optical cable, by radio or by other means, so that the computer program that it contains is executable remotely. In particular, the program according to the invention may be downloaded over a network, for example the Internet network.

### LIST OF THE FIGURES

Other aims, features and advantages of the invention will appear more clearly upon reading the following description, given as a simple illustrative and non-limiting example, with reference to the figures, wherein:

FIG. 1: this figure shows a PON-type network according to the prior art,

FIG. 2: this figure shows a PON-type network wherein the interference diagnosis method according to the present invention,

FIG. 3: this figure shows the steps implemented by the different pieces of termination equipment of the PON network during the execution of the method for diagnosing interferences generated by at least one first termination device embedded in a first ONU on at least one second termination device embedded in a second ONU,

FIG. 4: this figure shows a first transmission schedule,

FIG. 5: this figure shows the steps implemented by the different pieces of termination equipment forming the PON network during the execution of the method for diagnosing interferences generated by at least one first termination device embedded in the OLT on the second termination device also embedded in the OLT knowing that the first termination device complies with the G-PON technology, complies with the XGS-PON technology, and the second termination device complies with the XGS-PON technology,

FIG. 6: this figure shows a second transmission schedule,

FIG. 7: this figure shows an interference diagnosis module able to implement the interference diagnosis method object of the present invention.

### DETAILED DESCRIPTION OF EMBODIMENTS OF THE INVENTION

The general principle of the invention is based on the implementation of a test campaign within a PON during which the impact of the transmission of a first so-called test optical signal by a first termination device of the PON on at least another termination device of the PON is assessed.

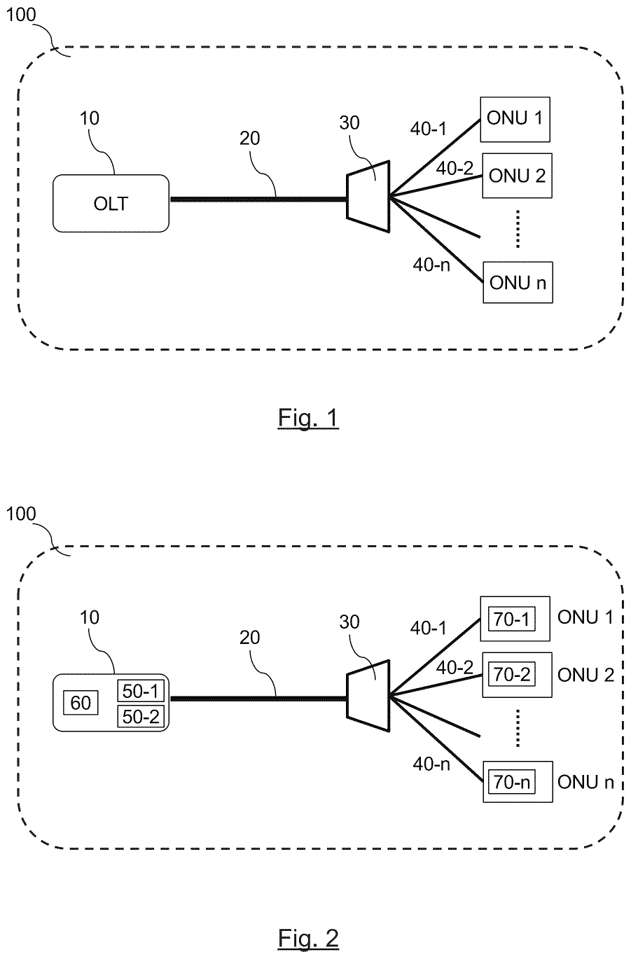

A PON-type network 100 is now described with reference to FIG. 2. The components of this network 100 described hereinabove with reference to FIG. 1 keep the same references.

The network 100 comprises an optical line terminal 10 located at the level of the optical central office (or CO, standing for “Central Office”) connected to an optical coupler 30 via a first optical fiber 20, as well as a set of user modules ONU-i, where i∈{1, . . . , n}. The user modules ONU-i are respectively connected to the coupler 30 by means of a dedicated optical fiber 40-i where i∈{1, . . . , n}. A branch B-i of the network 100 consists of the optical fiber 20, the coupler 30 and an optical fiber 40-i. Thus, each ONU-i is connected to the OLT 10 by means of a dedicated branch B-i.

The OLT 10 and the ONUs-i are commonly so-called termination equipment since each is located at an end of a constituent branch B-i of the network 100.

In the example shown in FIG. 2, the OLT 10 comprises two termination devices 50-1 and 50-2. A termination device 50-1, 50-2 is an optoelectronic device comprising means for transmitting an optical signal at a transmission power and at a given wavelength and means for receiving an optical signal transmitted by at least one other termination device.

It should be understood that the OLT 10 may comprise one single termination device 50-1, 50-2 or more than two termination devices 50-1, 50-2. In the remainder of the present document, the termination device 50-1 complies with the G-PON technology, complies with the XGS-PON technology, and the termination device 50-2 complies with the XGS-PON technology. Thus, the termination device 50-1 transmits at a first wavelength specific to this technology and the termination device 50-2 transmits at a second wavelength specific to this technology distinct from the first wavelength.

In the example shown in FIG. 2, an ONU-i comprises a termination device 70-i. A termination device 70-1 is an optoelectronic device comprising means for transmitting an optical signal at a transmission power and at a given wavelength and means for receiving an optical signal transmitted by at least one other termination device.

It should be understood that an ONU-i may comprise more than one termination device 70-i. In the remainder of the present document, the termination device 70-1 embedded in the ONU-1 complies with the G-PON technology, complies with the XGS-PON technology, and the termination device 70-2 embedded in the ONU-2 complies with the XGS-PON technology. Thus, the termination device.

As already explained with reference to FIG. 1, the termination device 50-1 transmits to the ONUs-i a downlink optical signal and each termination device 70-i embedded in an ONU-i transmits to the OLT 10 an uplink optical signal within a time interval that is specific thereto. For the OLT 10 to be able to identify the uplink optical signal specific to each ONU-i, a transmission schedule is imposed beforehand on each ONU-i.

Finally, in the example shown in FIG. 2, the OLT 10 embeds an interference diagnosis module 60 whose function will be better understood upon reading the remainder of the present document. In other implementations of the present invention, the interference diagnosis module 60 may be located in a remote server with which the OLT can communicate in order to exchange data relating to the establishment of an interference diagnosis.

FIG. 3 shows the steps implemented by the different pieces of termination equipment 10, ONU-i forming the network 100 during the execution of the method for diagnosing interferences generated by at least one first termination device 70-1 embedded in the ONU-1 on at least one second termination device 70-i embedded in an ONU-i with i different from 1.

In a first step E1, the interference diagnosis module 60 transmits, in a message MSG1 to the OLT 10 and the ONUs-i, a transmission schedule CalUp relating to a test campaign to be performed within the network 100 for the uplink communication direction, i.e. for optical signals transmitted by the different ONUs-i to the OLT 10.

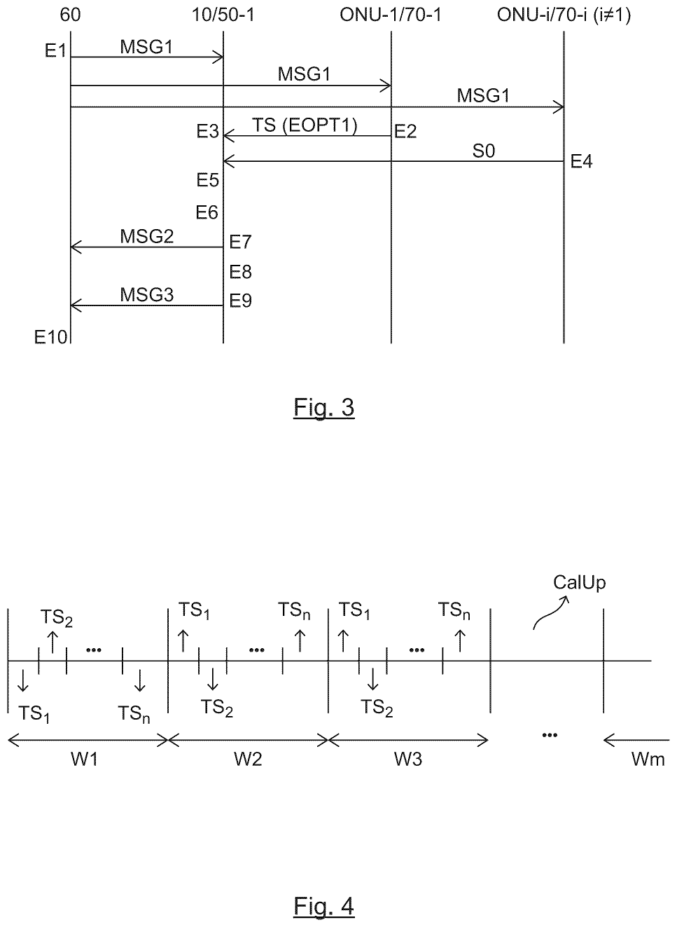

Such a transmission schedule CalUp is shown with reference to FIG. 4. Such a transmission schedule CalUp comprises a plurality of transmission windows Wj, j∈{1, . . . , m}. Each transmission window Wj is itself split into a plurality of time intervals TSi, i∈{1, . . . , n}. For each transmission window Wj, the first time interval TS1 is assigned to the termination device 70-1 object of the test campaign, the other time intervals TSi, with i different from 1, are allocated to the other ONUs-i, for example, the time interval TS2 is allocated to the ONU-2, the time interval TS3 is allocated to the ONU-3, etc.

For each first time interval TS1 of each time window Wj, the message MSG1 comprises an indication of a value of a transmission optical power EOPT that the termination device 70-1 should use during the transmission of the test signal TS, the value of this transmission power EOPT of the test optical signal TS varying from one time window to another.

Upon reception of the message MSG1, the ONUs-i wait for the start time of the time interval TSi which is allocated thereto in the first transmission window W1 in order to transmit an optical signal to the OLT 10.

Thus, in step E2, the termination device 70-1 transmits the test optical signal TS at a first transmission optical power value EOPT1 to the OLT 10.

In step E3, the termination device 50-1 embedded in the OLT 10 receives the test signal TS.

In accordance with the transmission schedule CalUp, at the start time of the time interval TS2, the termination device 70-2 embedded in the ONU-2 transmits, during a step E4, an optical signal SO at the nominal transmission power to the OLT 10.

In step E5, upon reception of the optical signal SO, the OLT 10 measures a value of a reception quality indicator IQR of the optical signal SO received by the termination device 50-1. Such a reception quality indicator IQR of the received optical signal SO may be a reception power level of the optical signal SO measured by the termination device 50-1 or a bit error rate of the optical signal SO estimated by the termination device 50-1.

In step E6, the OLT 10 proceeds with a comparison of the value of the reception quality indicator IQR of the received optical signal SO with a first threshold S1.

When the value of the reception quality indicator IQR of the received optical signal SO is lower than or equal to the threshold S1, the OLT 10 transmits, in step E7, a message MSG2 comprising an identifier of the termination device 70-1, an identifier of the device 70-2 and the first transmission optical power value EOPT1 to the interference diagnosis module 60.

In step E8, the OLT 10 also proceeds with a comparison of the value of the reception quality indicator IQR of the received optical signal SO with a second threshold S2 lower than the first threshold S1.

When the value of the reception quality indicator IQR of the received optical signal SO is lower than or equal to the threshold S2, the OLT 10 transmits, in step E9, a message MSG3 comprising an identifier of the termination device 70-1, an identifier of the device 70-2 and the first transmission optical power value EOPT1 as well as an off-hook information IDec of the termination device 70-2 to the interference diagnosis module 60.

Steps E2 to E9 are repeated for each time interval TSi of a time window Wj, and therefore for all of the recipient ONUs-I of the transmission schedule CalUp, and for all of the m windows Wj that the transmission schedule CalUp includes.

Once all of the measurements of the test campaign have been performed, the interference diagnosis module 60 is in possession of all of the data necessary for the establishment of a diagnosis of the interferences generated by the termination device 70-1 on the termination devices 70-i, with i different from 1, according to the values of at least one reception quality indicator IQR obtained for each of the termination devices 70-i as well as, where appropriate, the data comprised in the messages MGS2 and MSG3.

Thus, in step E10, the interference diagnosis module 60 establishes a diagnosis of interferences generated by the termination device 70-1 on the different termination devices 70-i, with i different from 1.

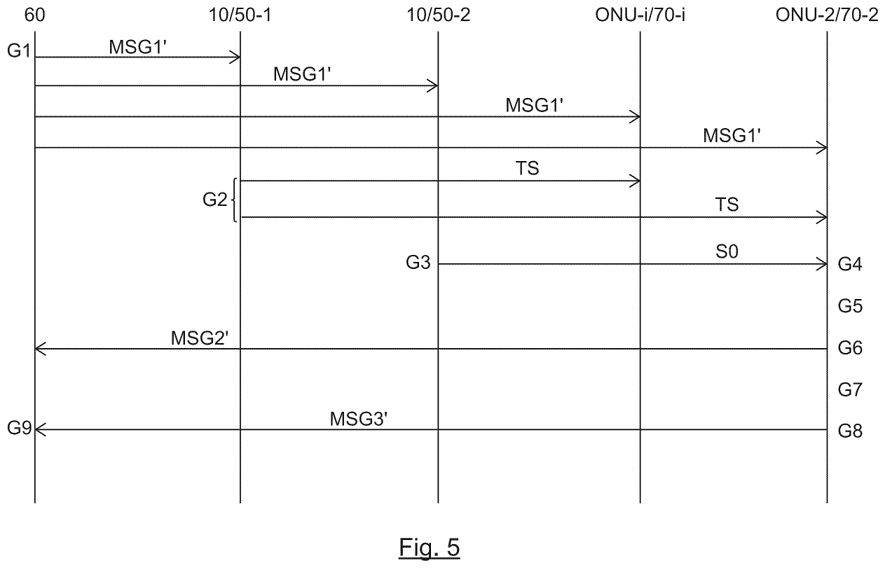

FIG. 5 shows the steps implemented by the different pieces of termination equipment 10, ONU-i forming the network 100 during the execution of the method for diagnosing interferences generated by at least one first termination device 50-1 embedded in the OLT 10 on the second termination device 50-2 also embedded in the OLT 10 knowing that the termination device 50-1 is compliant with the G-PON technology, is compliant with the XGS-PON technology, and the termination device 50-2 is compliant with the XGS-PON technology.

In a first step G1, the interference diagnosis module 60 transmits, in a message MSG1′ to the OLT 10 and the ONUs-i, a transmission schedule CalDw relating to a test campaign to be performed within the network 100 for the downlink communication direction, i.e. for optical signals transmitted by the different termination devices 50-1 and 50-2 to the different ONUs-i.

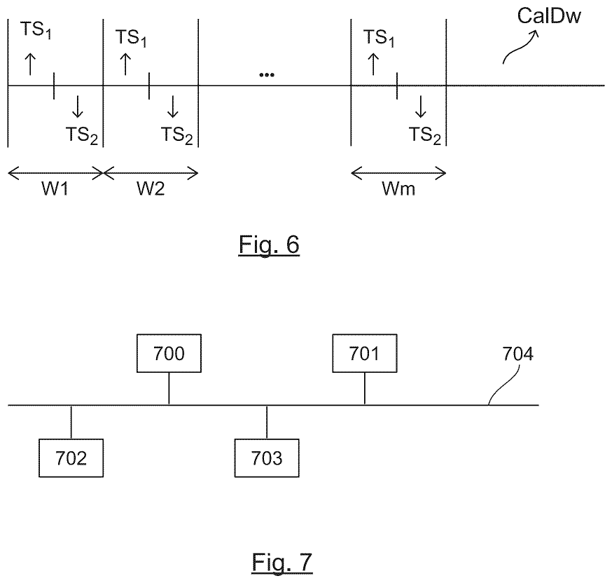

Such a transmission schedule CalDw is shown with reference to FIG. 6, such a transmission schedule CalDw comprises a plurality of transmission windows Wj, j∈{1, . . . , m}. Each transmission window Wj is, itself, split into two time intervals TS1 and TS2. For each transmission window Wj, the first time interval TS1 is assigned to the termination device 50-1 object of the test campaign, and the second time interval TS2, to the termination device 50-2.

For each first time interval TS1 of each time window Wj, the message MSG1′ comprises an indication of a value of a transmission optical power EOPT that the termination device 50-1 should use during the transmission of the test signal TS, the value of this transmission power EOPT of the test optical signal TS varying from one time window to another.

Upon reception of the message MSG1′, the termination devices 50-1 and 50-2 wait for the start time of the time interval TS1 or TS2 which is allocated thereto in the first transmission window W1 in order to transmit an optical signal to the ONU-i.

Thus, in step G2, the termination device 50-1 transmits the test optical signal TS at a first transmission optical power value EOPT1 throughout the network 100.

In accordance with the transmission schedule CalDw, at the start time of the time interval TS2, the termination device 50-2 transmits, during a step G3, an optical signal SO at the nominal transmission power to the ONU-2 which is the only one, in the described example, to have a termination device 70_2 able to implement the XGS-PON and therefore capable of receiving and proceeding with measurements on the signal SO.

In step G4, upon reception of the optical signal SO, the ONU-2 measures a value of a reception quality indicator IQR of the optical signal SO received by the termination device 70-2. Such a reception quality indicator IQR of the received optical signal SO may be a reception power level of the optical signal SO measured by the termination device 70-2 or a bit error rate of the optical signal SO estimated by the termination device 70-2.

In step G5, the ONU-2 proceeds with a comparison of the value of the reception quality indicator IQR of the received optical signal SO with a first threshold S1.

When the value of the reception quality indicator IQR of the received optical signal SO is lower than or equal to the threshold S1, the ONU-2 transmits, in step G6, a message MSG2′ comprising an identifier of the termination device 50-1, an identifier of the device 50-2 and the first transmission optical power value EOPT1 to the interference diagnosis module 60 either directly or via the OLT 10 which then serves as a relay.

In step G7, the ONU-2 also proceeds with a comparison of the value of the reception quality indicator IQR of the received optical signal SO with a second threshold S2 lower than the first threshold S1.

When the value of the reception quality indicator IQR of the received optical signal SO is lower than or equal to the threshold S2, the ONU-2 transmits, in step G8, a message MSG3′ comprising an identifier of the termination device 50-1, an identifier of the device 50-2 and the first transmission optical power value EOPT1 as well as an off-hook information IDec of the termination device 50-2 to the interference diagnosis module 60 either directly or via the OLT 10 which then serves as a relay.

Steps G2 to G8 are repeated for all of the m windows Wj included in the transmission schedule CalDw.

Once all of the measurements of the test campaign have been performed, the interference diagnosis module 60 is in possession of all of the data necessary for the establishment of a diagnosis of the interferences generated by the termination device 50-1 on the termination device 50-2 as a function of the values of at least one reception quality indicator IQR obtained for the termination device 50-2 as well as, where appropriate, the data included in the messages MGS2′ and MSG3′.

Thus, in step G9, the interference diagnosis module 60 establishes a diagnosis of interferences generated by the termination device 50-1 on the termination device 50-2.

FIG. 7 shows an interference diagnosis module 60 able to implement the interference diagnosis method object of the present invention.

An interference diagnosis module 60 may comprise at least one hardware processor 700, a storage unit 701, a first interface 702, and at least one second interface 703 which are connected together throughout a bus 704. Of course, the constituent elements of the interference diagnosis module 60 may be connected by means of a connection other than a bus. In one embodiment, the interference diagnosis module 60 is embedded in the OLT 10.

The processor 700 controls the operations of the interference diagnosis module 60. The storage unit 701 stores at least one program for implementing the method object of the invention to be executed by the processor 700, and various data, such as parameters used for calculations performed by the processor 700, intermediate data of calculations performed by the processor 700, etc. The processor 700 may be formed by any known and suitable hardware or software, or by a combination of hardware and software. For example, the processor 700 may be formed by a dedicated hardware such as a processing circuit, or by a programmable processing unit such as a central processing unit (Central Processing Unit) which executes a program stored in a memory of the latter.

The storage unit 701 may be formed by any suitable means capable of storing the program or the programs and data in a computer-readable manner. Examples of storage units 701 include computer-readable non-transitory storage media such as semiconductor memory devices, and magnetic, optical or magneto-optical recording media loaded in a read-and-write unit.

The first interface 702 provides an interface between the interference diagnosis module 60 and at least one termination device 50-1, 50-2 embedded in the OLT 10.

In turn, the second network interface 703 provides a connection between the Interference diagnosis module 60 and the ONUs-i.

1. An interference diagnosis method for diagnosing interferences generated by at least one first termination device, located at an end of a first branch of a passive optical communication network (PON), on at least one second termination device located at an end of at least one second branch of said PON, said method comprising the following steps implemented by an interference diagnosis device:
transmitting to said at least one first termination device a request to transmit at least one first optical signal, called a test signal, at a first transmission power;
transmitting to said at least one second termination device a request to transmit at least one second optical signal at a second transmission power, called nominal power;
obtaining, for said second optical signal, at least one measurement of a value of at least one indicator of quality of reception of said second optical signal by a third termination device; and
establishing the interference diagnosis of said at least one second termination device as a function of said measured value of at least one reception quality indicator of said second optical signal.

2. The interference diagnosis method according to claim 1, comprising, prior to establishing said interference diagnosis:
transmitting, to said at least one first termination device and to said at least one second termination device a transmission schedule of said test optical signal and of said at least one second optical signal, said transmission schedule being divided into a succession of transmission windows, each of the transmission windows comprising:
a first time interval during which said first termination device is authorized to transmit said test optical signal; and
at least one second time interval during which said at least one second device is authorized to transmit said second optical signal at the nominal transmission power, a value of the first transmission power of said test optical signal varying from one time window to another.

3. The interference diagnosis method according to claim 1, wherein the obtaining the at least one measurement of the value of at least one reception quality indicator of said second optical signal comprises:
comparing said measured value of at least one reception quality indicator of said second optical signal with a first threshold; and
in response to the measured value of at least one reception quality indicator of said second optical signal being lower than or equal to the first threshold, memorizing an identifier of the first termination device, an identifier of the second termination device and a value of said first transmission power.

4. The interference diagnosis method according to claim 3, wherein the obtaining the at least one measurement of the value of at least one reception quality indicator of said second optical signal further comprises:
comparing said measured value of at least one reception quality indicator of said second optical signal with a second threshold lower than the first threshold;
in response to the measured value of at least one reception quality indicator of said second optical signal being lower than or equal to the second threshold, memorizing the identifier of the first termination device, the identifier of the second termination device, the value of said first transmission power, and off-hook information of the second termination device.

5. The interference diagnosis method according to claim 1, wherein said at least one reception quality indicator of said second optical signal belongs to the group consisting of:
a reception power level of said second optical signal measured by said third termination device;
a bit error rate of said second optical signal estimated by said third termination device.

6. The interference diagnosis method according to claim 1, wherein, the PON comprises an optical central office connected to at least one first line termination equipment via at least one optical fiber forming said first branch of said PON and to at least one second line termination equipment via at least one other optical fiber forming said at least one second branch of said PON, said at least one first termination device is embedded in the first line termination equipment, said at least one second termination device is embedded in the second line termination equipment, and the third termination device is embedded in the optical central office.

7. The interference diagnosis method according to claim 1, wherein, the PON comprises an optical central office connected to at least one first line termination equipment via at least one optical fiber forming said first branch of said PON and to at least one second line termination equipment via at least one other optical fiber forming said second branch of said PON, the at least one first termination device is embedded in the optical central office and transmits said test signal to said at least one first termination equipment, said at least one second termination device is also embedded in the optical central office and transmits said at least one second optical signal to said at least one second termination equipment, and the third termination device is embedded in the second termination equipment.

8. A interference diagnosing device for diagnosing interferences generated by at least one first termination device, located at an end of a first branch of a passive optical communication network (PON), on at least one second termination device located at an end of at least one second branch of said PON, said interference diagnosis device comprising:
at least one processor configured to:
transmit to said at least one first termination device a request to transmit at least one first optical signal, called a test signal, at a first transmission power;
transmit to said at least one second termination device a request to transmit at least one second optical signal at a second transmission power, called nominal power;
obtain, for said second optical signal, at least one measurement of a value of at least one indicator of quality of reception of said second optical signal by a third termination device; and
establish the interference diagnosis of said at least one second termination device as a function of said measured value of at least one reception quality indicator of said second optical signal.

9. The interference diagnosis device according to claim 8, wherein the PON comprises an optical central office connected to at least one first line termination equipment via at least one optical fiber forming said first branch of said PON and to at least one second line termination equipment via at least one other optical fiber forming said second branch of said PON, and said interference diagnosis device is embedded in the optical central office.

10. A non-transitory computer readable medium comprising stored program code instructions for executing an interference diagnosing method when the instructions are executed by at least one processor, wherein the instructions configure the at least one processor to:
diagnose interferences generated by at least one first termination device, located at an end of a first branch of a passive optical communication network (PON), on at least one second termination device located at an end of at least one second branch of said PON, the diagnosing comprising:
transmitting to said at least one first termination device a request to transmit at least one first optical signal, called a test signal, at a first transmission power;
transmitting to said at least one second termination device a request to transmit at least one second optical signal at a second transmission power, called nominal power;
obtaining, for said second optical signal, at least one measurement of a value of at least one indicator of quality of reception of said second optical signal by a third termination device; and
establishing the interference diagnosis of said at least one second termination device as a function of said measured value of at least one reception quality indicator of said second optical signal.

11. The interference diagnosis method according to claim 1, wherein the interference diagnosis device is implemented in the at least one second termination device or in a remote server with which the at least one second termination device can communicate.
